(19) United States
(12) Patent Application Publication
(10) Pub. No.: US 2017/0332445 A1
(43) Pub. Date: Nov. 16, 2017

(54) STOVETOP HEAT MANAGEMENT SYSTEM

(71) Applicant: Joe INOCENCIO, Houston, TX (US)

(72) Inventor: Joe INOCENCIO, Houston, TX (US)

(21) Appl. No.: 15/053,836

(22) Filed: Feb. 25, 2016

(51) Int. Cl. H05B 3/74; F24C 3/12; F24C 15/10; B32B 15/01

(52) U.S. Cl. CPC H05B 3/746; F24C 15/105; F24C 3/128; B32B 15/011; H05B 2213/04

(57) ABSTRACT

A food warming system involving a heat sink component, a warming plate, and an intervening insulation and heat- or fire-resistant layer that moderates the flow of heat from a charged heat sink component to the warming plate on which a vessel containing food is placed to maintain food in a heat-regulated state.

### BACKGROUND OF THE INVENTION

### 1. Field of the Invention

The present invention relates to cooking implements and warming devices involved in the preparation and the maintenance of cooked foods.

### 2. Background Information

Maintaining the elevated temperature of cooked foods is nearly as old as cooking itself. Even in relatively modern times, this included leaving cooking implements (pots, pans, etc.) on a stove top with lowered temperature settings or configurations, in an oven (likewise with reduced temperature settings or configurations), set atop a separate warming tray, or placed beneath a high intensity, infrared light bulb warming system.

Nearly all of the conventional methods for keeping hot foods hot involve some degree of inconvenience, and in many cases outright safety hazards. For example, having a warming tray or other food heating system, apart from one's oven or range itself, consumes extra space, involves extra expense, and requires extra cleaning. Of more significance is that other mentioned methods for maintaining food temperatures also involve some degree of safety hazards. For example, leaving a stove top or oven “on”, even at a low setting, involves the possibility of the cook forgetting about this arrangement, leaving the food for a prolonged period in that setting, and resulting in at least overcooked foods or, at most, risking a fire under circumstances that are easy to imagine. In fact, its reported that 40% of house fires and 36% of fire-related injuries are caused by cooking fires, as most cooking fires start with an oven or stove left unattended.

### SUMMARY OF THE INVENTION

In view of the foregoing, it would be preferable (from a convenience and safety standpoint) to have available to cooks some means for maintaining the elevated temperature of cooked food that does not involve significant, space consuming systems or appliances, does not require but allows that the range or oven be left on, and very nearly eliminates the possibility of food becoming overcooked or brought ablaze.

In satisfaction of such needs and concerns, the present inventor has invented a simple, safe, and cost-effective system for maintaining elevated food temperatures that avoids all of the recited limitations of prior methods, and hazards thereof.

An embodiment of the present invention involves a single-unit cooking implement such as a shallow pan or skillet, a circular, metallic plate that is sized to nest within the interior of such pan or skillet, and an intervening layer of heat or fire resistant material. In use, the pan or skillet is heated while stovetop, and, even whether or not the heat source is terminated, residual, controlled and regulated heat rises through the heat/fire resistant material and the plate to continue a regulated, controlled heating of any food-containing vessel placed thereon. It is because of the heat or fire resistant layer that the flow of heat from the pan or skillet to and through the metallic plate is moderated and, therefore, only such measure of heat as “warms” (but does not overcook or burn) any food in the vessel placed thereon.

By slowly “restricting” the flow of heat from the already heated skillet or pan, whether there is the continuation of heat source, the reduction of heat source or the termination of heat source, all safety hazards associated with doing so are thereby eliminated.

### BRIEF DESCRIPTION OF THE DRAWINGS

FIG. 1 is a perspective view of the elements of a preferred embodiment of the present warming system.

### DETAILED DESCRIPTION OF THE PREFERRED EMBODIMENT

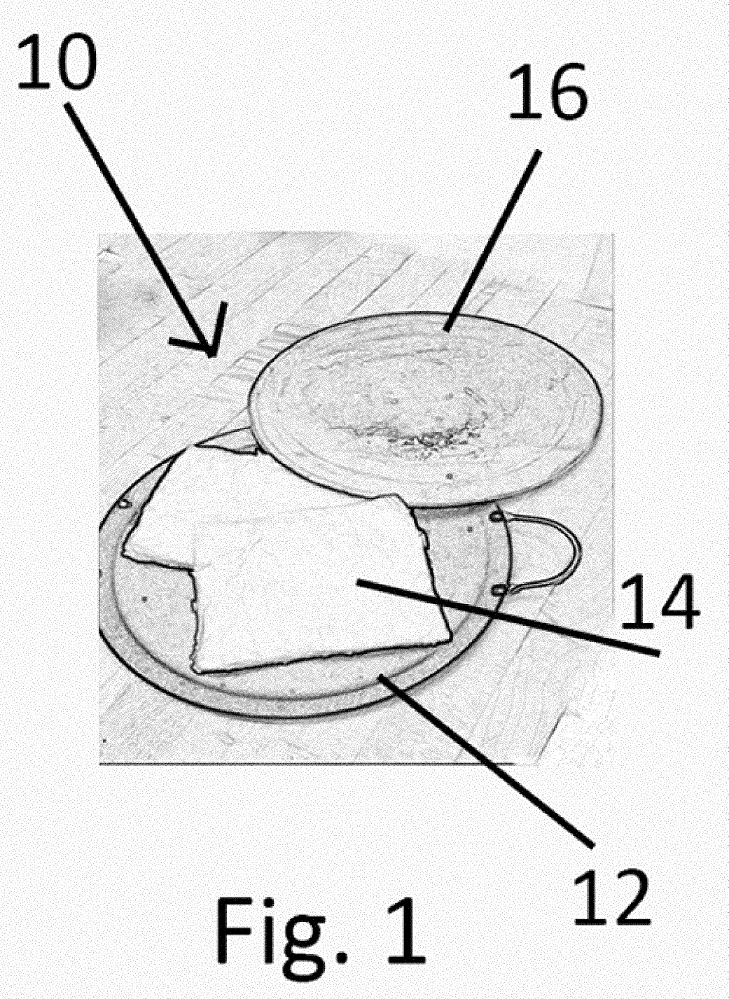

Referring to FIG. 1, a preferred embodiment of the present warming system 10 includes a pot or pan 12 (“heat sink component”), or the functional equivalent (even if specifically fashioned for this purpose). The ideal heat sink component would be of a material that absorbs and retains a significant amount of heat. Cast iron is one example. Conversely, aluminum, for example, would generally not be preferable, because aluminum rapidly dissipates heat to which it is exposed. Heat sink component 12 should be configured such that a warming plate 16 nests within its interior bounds. Warming plate 16 may be of comparable material to that of heat sink component 12, however this is not as critical as with the material choice of heat sink component 12, because warming plate 16's purpose is to transmit heat received from beneath it to any vessel placed thereon.

As mentioned above, intervening heat sink component 12 and warming plate 16 is a layer of heat resistant material (insulating layer) 14. Insulating layer 14 serves to regulate the flow of heat from heat sink component 12 to warming plate 16, and ultimately to any vessel placed upon warming plate 16 (not shown in the FIGURES). Insulating layer 14 may be of any nonflammable, insulating and durable material, with a relatively high melting point. The material from which “oven mitts” are made (at least the lining material) would be one example. In the alternative, another choice maybe of silicon material formed to fit as described in between heat sink component 12 and warming plate 16, such material being that from which silicone bakeware is made, would be another possible choice. The governing consideration is that the insulating, fire-resistant layer does, in fact, “insulate”, while controlling and regulating heat used to keep items above the same warm, while not or becoming damaged in any material way. Furthermore, the insulating, fire-resistant layer 14 may be fashioned as a single component, or as multiple ones as shown in FIG. 1.

Once configured, use of the current warming system 10 involves placing the heat sink component 12 atop a heat source (typically a range top burner) to “charge” the heat sink component with heat from the heat source. This may be followed by terminating the heat source (if not already done), inserting the insulating layer 14 into the interior space of the heat sink component 12, placing the warming plate 16 atop the insulating layer 14, and ultimately placing a food-containing vessel a top warming plate 16. Or, the heat source may remain, whether reduced or not, and yet the food to be warmed will not overcook or burn, due primarily to the insulating, fire-resistant layer.

Already cooked food and a vessel atop the assembled and “charged” warming system 10 will remain warm for so long as the heat sink component 12 continues to emit heat through insulating later 14 and warming plate 16. Heat emission will be considerably longer, and more regulated than would otherwise be possible without the assemblage as described herein. A result of all of the foregoing is that the food will not further cook, there is no risk of burning or fire, and all of the other inconveniences and hazards described above are fully avoided.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A food vessel warming system comprising:
a heat sink component that defines a bounded interior space;
a warming plate having a substantially flat food vessel resting surface, said warming plate being configured for nested positioning within said bounded interior space of said heat sink component with said food vessel resting surface facing outward from said bounded interior space; and
insulating means intervening said heat sink component and said warming plate.

2. The system of claim 1 wherein said heat sink component is configured from a metallic material.

3. The system of claim 1 wherein said heat sink component is configured so safely from Materials selected from a group consisting of iron, steel, or stainless steel.
